(19) United States
(12) Patent Application Publication
(10) Pub. No.: US 2011/0011724 A1
(43) Pub. Date: Jan. 20, 2011

(54) Method of utilizing cooling tower concentrate discharge to transfer waste heat to the atmosphere

(76) Inventor: Ralph Schmitt, Thousand Oaks, CA (US)

Correspondence Address: LAW OFFICES OF JOSEPH R. CRUSE, JR., 28215 AGOURA ROAD, SUITE 130, AGOURA HILLS, CA, 91301, US

(21) Appl. No.: 12/460,348

(22) Filed: Jul. 17, 2009

(51) Int. Cl. C02F 1/04

(52) U.S. Cl. 203/10

(57) ABSTRACT

An improved system to reduce the volume of makeup water necessary for the operation of a cooling tower, which system includes a combination of a floating heat exchanger and a cooling tower in such a manner that the wastewater discharged from the cooling tower is added to a surface impoundment equipped with said floating heat exchanger.

### BACKGROUND OF THE INVENTION

1) Field of the Invention

The present invention relates to the combination of a floating heat exchanger and a surface impoundment used for the disposal of wastewater concentrate by evaporation of liquid, usually water, to the atmosphere. In the present embodiment, a portion of the waste heat load normally transferred to the atmosphere by evaporation of water in a cooling tower is transferred to the surface water of the concentrate disposal surface impoundment thereby increasing the rate of evaporation from the concentrate disposal surface impoundment. In this manner, the concentrated salt solution normally discharged from the cooling tower, commonly known in the industry as blowdown, is used to transfer waste heat to the atmosphere in the same manner as the cooling tower. The net effect is the utilization of 100% of the makeup water to the cooling tower for the transfer of low-grade waste heat to the atmosphere.

The present invention can beneficially use the concentrated wastewater normally discharged from cooling towers as waste. It can be applied to cooling towers used for industrial manufacturing operations, interior space cooling of buildings and concentrate disposal generated by the demineralization of brackish water supplies. It can potentially reduce the amount of water required by a cooling tower from 10% to 50%.

2) Description of the Prior Art

A cooling tower is a standard unit of industrial process equipment that accomplishes the task of transferring low-grade heat, commonly referred to as “waste-heat” to the atmosphere as a necessary condition for continuous operation. The primary function of a cooling tower is to transfer waste heat to the atmosphere. It does this by using the waste heat to evaporate water in the cooling tower. The evaporated water is then transferred to the atmosphere as water vapor carrying with it the latent heat of vaporization. The cooling tower is designed and operated in such a manner to maximize the surface area of contact between atmospheric air and the, usually water based, evaporation liquid.

Each pound of water evaporated from the cooling tower transfers approximately 1,100 BTU of low-grade waste heat to the atmosphere. Makeup water must be continuously added to the cooling tower so that it can be operated continuously. Since pure water is evaporated from the cooling tower and the makeup water contains a variable amount of dissolved salts and suspended solids, a small stream of water must be continually discharged from the cooling tower as a preventive maintenance measure.

If this small stream of liquid is not continuously discharged from the cooling tower, the cooling tower liquid will become saturated with a mixture of dissolved salt and suspended solids that will form a coating of scale on the wetted parts of the cooling tower. When this happens, the cooling tower will no longer be capable of performing its intended function of transferring low-grade waste heat to the atmosphere by evaporative cooling.

The present art of cooling tower operation and maintenance limits the effective use of water for evaporative cooling to approximately 80% of the volume of makeup water added to the cooling tower. The remaining water, as much as 20%, is discharged as wastewater to a waste disposal process.

### SUMMARY OF THE INVENTION

A basic embodiment of the invention described in U.S. Pat. No. 6,276,872 is where the invention is operated in conjunction with a cooling tower in such a manner that the wastewater discharged from the cooling tower is added to a surface impoundment equipped with a floating heat exchanger of the present invention. The wastewater discharged by the cooling tower becomes makeup water for the surface impoundment equipped with a floating heat exchanger. This manner of using the present invention in conjunction with a cooling tower can reduce the volume of water needed for evaporative cooling from 10% to as much as 50%.

It does this by its ability to continuously evaporate water from the saturated salt solution in the surface impoundment. As water evaporates from the surface of the impoundment, the saturated salts precipitate and settle to the bottom of the impoundment. Over time, the accumulation of salt precipitate on the impoundment bottom will occupy an ever greater portion of the impoundment volume until the floating heat exchanger is no longer separated from the salt precipitate on the impoundment bottom. The net effect is a substantial reduction in the volume of water required for evaporative cooling and concentration of the cooling tower blowdown stream as a mixture of wet salt precipitate and suspended solids.

The floating heat exchanger is constructed of High Density Polyethylene (HDPE) plastic tubes that are inherently adhesion resistant. This property makes them resistant to the accumulation of precipitates (water hardness scale) on the exterior surfaces of the HDPE pipes that are exposed to the concentrates in the surface impoundment.

If water hardness scale does accumulate on the exterior surfaces of the HDPE pipes, it can be easily removed by rolling the floating heat exchanger onto a shore mounted drum. The process of bending the flexible HDPE pipe over the curved surface of the drum will cause most brittle water hardness scale to crack and fall from the exterior surface of the HDPE pipe.

The surface impoundment filled with a mixture of wet salt precipitate and suspended solids can be closed in place or the accumulated wet solids can be transported to a land disposal site approved for this use.

### DRAWINGS—FIGURES

In the drawings, closely related figures have the same number but different alphabetic suffixes.

FIG. 1 shows a flow chart diagram of a typical Cooling Tower Operation that exists in the Prior Art.

FIG. 2 shows a flow chart diagram of a typical Cooling Tower Operation combined with a Solar Evaporation Surface Impoundment with Floating Heat Exchanger.

### DRAWINGS—Reference Numerals

1 Cooling Tower
2 Cooling Tower Blowdown
3 Solar Evaporation Surface Impoundment
4 Circulating Pump
5 Cooling Water Supply
6 Process Producing Low-Grade Waste Heat
7 Cooling Water Return
8 Solar Evaporation Surface Impoundment with Floating Heat Exchanger
9 Floating Heat Exchanger Circulating Pump

### DETAILED DESCRIPTION

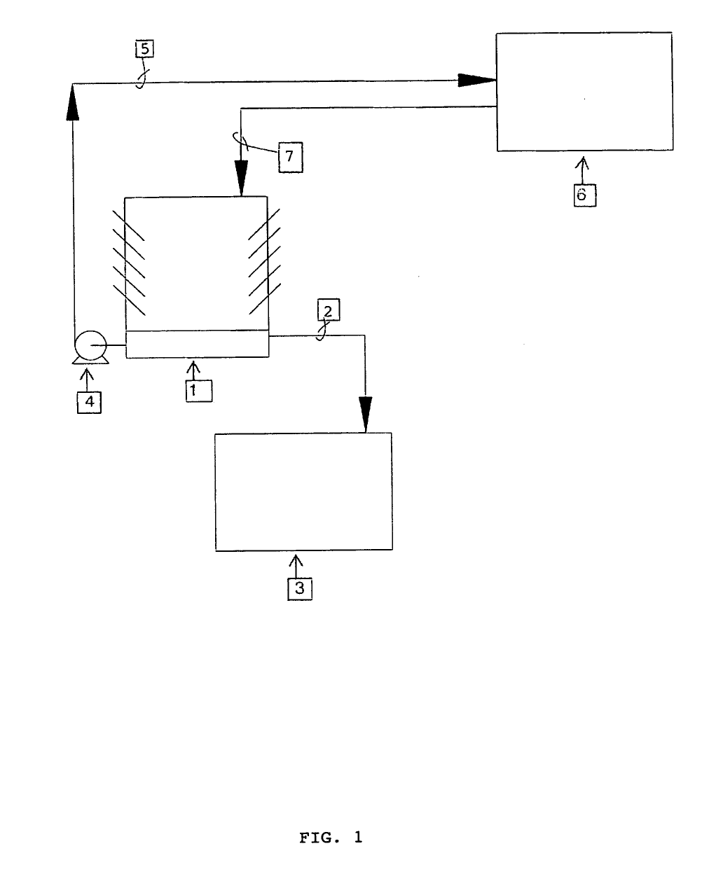

FIG. 1—Prior Art

A typical embodiment of the apparatus and method of the prior art of the present invention is illustrated in FIG. 1.

The Cooling Tower (1) discharges wastewater as Cooling Tower Blowdown (2) into a Solar Evaporation Surface Impoundment (3). The Solar Evaporation Surface Impoundment (3) naturally evaporates the Cooling Tower Blowdown (2).

The remaining portion of the Cooling Tower Blowdown (2) that is not discharged to the Solar Evaporation Surface Impoundment (3) is sent via a Circulating Pump (4) as Cooling Water Supply (5) to a Process Producing Low-Grade Waste Heat (6) which returns water to the Cooling Tower (1) as Cooling Water Return (7).

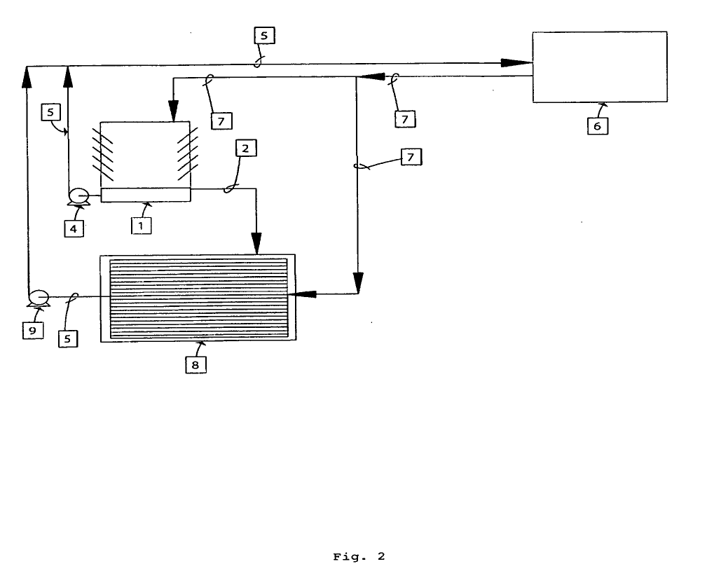

FIG. 2—Preferred Embodiment

A preferred embodiment of the apparatus and method of the present invention is illustrated in FIG. 2.

The Cooling Tower (1) discharges wastewater as Cooling Tower Blowdown (2) into a Solar Pond with a Floating Heat Exchanger (8).

The Solar Pond with the Floating Heat Exchanger (8) produces a Heat Exchanger Cooling Water Supply (5) which is combined with the Cooling Tower Cooling Water Supply (5) which is pumped out of the Cooling Tower (1) by the Circulating Pump (4).

The Cooling Water Supply (5) here is combined from its two separate sources, the Heat Exchanger Cooling Water Supply (5) and Cooling Tower Cooling Water Supply (5).

This Cooling Tower Water Supply (5) is then is sent via the Floating Heat Exchanger Circulating Pump (9) to the Process Producing Low-Grade Waste Heat (6) which returns water to the Cooling Tower (1) as Cooling Water Return (7).

What is claimed is:

1. A method to reduce the volume of makeup water necessary for the operation of a cooling tower, said method comprising the steps of:
combining a floating heat exchanger with a cooling tower;
adding wastewater discharged from the cooling tower to a surface impoundment equipped with a floating heat exchanger;
said surface impoundment containing wastewater;
said wastewater containing upper surface water which is exposed to the atmosphere;
said wastewater containing a mixture of saturated salts and suspended solids;

2. A method to reduce the volume of makeup water for the operation of a cooling tower as defined in claim 1 wherein said step increases the evaporation rate of the wastewater from the saturated salts and suspended solids in the impoundment by adding heat to the surface water of the impoundment;

3. A method to reduce the volume of makeup water for the operation of a cooling tower as defined in claim 2 wherein said step precipitates the saturated salts and suspended solids in the impoundment to allow them to settle at the bottom of said impoundment;
settling the precipitated salts and solids over time to occupy an increasing portion of the volume of said impoundment until the floating heat exchanger is no longer separated from the precipitate on said impoundment bottom;

4. A method to reduce the size of a solar evaporation pond required for waste disposal by increasing the evaporation of said solar evaporation pond.
